(19) United States
(12) Patent Application Publication
(10) Pub. No.: US 2020/0137387 A1
(43) Pub. Date: Apr. 30, 2020

(54) ENCODER, DECODER, COMPUTER PROGRAM AND COMPUTER PROGRAM PRODUCT FOR PROCESSING A FRAME OF A VIDEO SEQUENCE

(71) Applicant: Huawei Technologies Co., Ltd., Shenzhen (CN)

(72) Inventors: Zhijie ZHAO, Munich (DE); Max BLAESER, Aachen (DE); Mathias WIEN, Aachen (DE)

(21) Appl. No.: 16/730,841

(22) Filed: Dec. 30, 2019

Related U.S. Application Data
(63) Continuation of application No. PCT/EP2017/066326, filed on Jun. 30, 2017.

(51) Int. Cl. H04N 19/119; H04N 19/176; H04N 19/46; H04N 19/91; H04N 19/147; H04N 19/50

(52) U.S. Cl. CPC H04N 19/119; H04N 19/176; H04N 19/50; H04N 19/91; H04N 19/147; H04N 19/46

(57) ABSTRACT

Methods for encoding and decoding a frame of a video sequence and corresponding encoder and decoder are provided. The encoder comprises a partitioning unit and an entropy coding unit, the partitioning unit is configured to receive a current block of the frame, obtain a template list including line information representing one or more candidate geometric partitioning (GP) lines, determine a final GP line that partitions the current block into two segments; select a GP line from the template list of one or more GP lines to obtain a selected GP line; and generate a GP parameter for the current block. The GP parameter includes an offset information indicating an offset between the final GP line and the selected GP line; the entropy coding unit is configured to encode the GP parameter.

### CROSS-REFERENCE TO RELATED APPLICATIONS

This application is a continuation of International Application No. PCT/EP2017/066326, filed on Jun. 30 2017, the disclosure of which is hereby incorporated by reference in its entirety.

### TECHNICAL FIELD

Embodiments of the present application relate to encoder and decoder for processing a frame of a video sequence. The encoder and decoder are particularly designed for processing a block of a video sequence.

### BACKGROUND

Most video coding techniques use prediction plus residual coding to model video images. Prediction is performed on each frame on a partition basis. That is, each frame is partitioned into blocks and then each block is partitioned into two, three or four segments. For example, quad tree partition separates a block into four parts.

As shown in FIG. 1, a block can be portioned by different ways. In FIG. 1, a simple scenario of a moving foreground object and a moving background is visualized. The quadtree-PU partitioning of HEVC and the related quad-tree-binary-tree partitioning method are representatives of rectangular block partitioning. Geometric partitioning is achieved by splitting the block with a straight line into two segments (also called wedges).

In case of geometric motion partitioning, the partitioning side-information per block consists of the line parameters, which specify how the block is sliced into two segments. Such line parameters can be specified in terms of two coordinate pairs, an angle and distance from the block center or otherwise, which increases coding load of encoder and decoder.

### SUMMARY

In view of the above-mentioned problems and disadvantages, the present application aims at improving the conventional approaches. An object of the present application is to provide an encoder and decoder and a respective encoding method and decoding method able to reduce the signaled side-information relating to partitioning structure of a block in a video frame.

Embodiments of the present application are defined in the enclosed independent claims. Further embodiments of the present application are defined in the dependent claims. In particular the present application proposes a partitioning unit and respective partitioning method.

A first aspect of the present application provides an encoder for encoding a frame in a video sequence. The encoder comprises a partitioning unit and an entropy coding unit, the partitioning unit is configured to receive a current block of the frame, obtain a template list including line information representing one or more candidate geometric partitioning (GP) lines, determine a final GP line that partitions the current block into two segments, select a GP line from the template list of one or more GP lines to obtain a selected GP line; and generate a GP parameter for the current block, wherein the GP parameter includes an offset information indicating an offset between the final GP line and the selected GP line. The entropy coding unit is configured to encode the GP parameter. The abbreviation of Geometric partition can be GP or GP in this application, which are used interchangeably.

By using the offset information, the present application minimizes the signaled side-information relating to the partitioning structure. Moreover, by using the template list, a candidate GP line can be generated even the neighbor block is non-partitioned.

In a first implementation form of the encoder according to the first aspect, the template list comprises for each candidate GP line of the one or more candidate GP lines a candidate GP line specific line information that may comprise any of the following information:

(1) a coordinate (x,y) indicating a start point and a coordinate indicating an end point of the respective candidate GP line of the one or more candidate GP lines, and
(2) a distance between the respective candidate GP line of the one or more candidate GP lines and a center of a template block, and an angle of the respective candidate GP line of the one or more candidate GP lines.

The information (1) above is a hardware-friendly integer based implementation since coordinates of the intersection points are integer value and hardware implementation always prefer to integer operation.

In a second implementation form of the encoder according to the first implementation form of the first aspect, the offset between the final GP line and the selected GP line comprises an offset between the start point of the selected GP line and a start point of the final GP line, and an offset between the end point of the selected GP line and an end point of the final GP line.

In a third implementation form of the encoder according to any implementation form of the first aspect, the template list comprises two or more candidate GP lines, the candidate GP line specific line information further comprises an index for each of the candidate GP lines, and the geometric partitioning parameter further includes an index of the selected GP line.

In a fourth implementation form of the encoder according to any implementation form of the first aspect, the template list comprises two or more candidate GP lines, and the partitioning unit is configured to select the candidate GP line from the template list that is closest to the final GP line as the selected GP line; or the partitioning unit is configured to select the candidate GP line from the template list such that a rate distortion is minimized.

In a fifth implementation form of the encoder according to any implementation form of the first aspect: wherein the partitioning unit is configured to determine the final GP line by: selecting a candidate GP line from the template list as an initial GP line;

repeatedly modifying the selected initial GP line to obtain a modified GP line, calculating a rate distortion cost for the modified GP line, and selecting the modified GP line as the final GP line if the rate distortion cost of the modified GP line is below or equal to a threshold; and/or repeatedly modifying the selected initial GP line to obtain a plurality of modified GP lines, calculating a rate distortion cost for each of the plurality of modified GP lines, and selecting the modified GP line with the smallest rate distortion cost.

In a sixth implementation form of the encoder according to any implementation form of the first aspect, the offset information comprises a step size and a quantized offset value, wherein an offset between the final GP line and the selected GP line corresponds to a product of the step size and the quantized offset value.

By using the step size and the quantized offset value, the signaled side-information relating to the partitioning structure is further minimized.

A further aspect of the present application provides an encoding method for encoding a frame in a video sequence. The encoding method comprises: receiving a current block of the frame, obtaining a template list including line information representing one or more candidate geometric partitioning, GP, lines, determining a final GP line that partitions the current block into two segments, selecting a GP line from the template list of one or more GP lines to obtain a selected GP line; generating a GP parameter for the current block, wherein the GP parameter includes an offset information indicating an offset between the final GP line and the selected GP line, and encoding the GP parameter.

Features of implementation forms of the encoding method of this further aspect correspond to the features of the respective implementation forms of the encoder of the first aspect.

A second aspect of the present application provides a decoder for decoding a frame in a video sequence. The decoder comprises an entropy decoding unit and a partitioning unit, wherein:

the entropy decoding unit is configured to decode an encoded geometric partitioning parameter for the current block; and,
the partitioning unit is configured to obtain a template list including line information representing one or more candidate geometric partitioning, GP, lines, select a GP line from the template list of the one or more GP lines to obtain a selected GP line, and obtain, based on the decoded geometric partitioning parameter and the selected GP line, the final GP line that partitions the current block into two segments, wherein the geometric partitioning parameter includes an offset information indicating an offset between the final GP line and the selected GP line.

By using the offset information, the present application minimizes the signaled side-information relating to the partitioning structure. Moreover, by using the template list, a candidate GP line can be generated even the neighbor block is non-partitioned.

In a first implementation form of the decoder according to a first implementation form of the second aspect, the template list comprises for each candidate GP line of the one or more candidate GP lines a candidate GP line specific line information that may comprise any of the following information:

(1) a coordinate (x,y) indicating a start point and a coordinate indicating an end point of each of the respective candidate GP line of the one or more candidate GP lines; and
(2) a distance between the respective candidate GP line of the one or more candidate GP lines and a center of a template block, and an angle of the respective candidate GP line of the one or more candidate GP lines.

The information (1) above is a hardware-friendly integer based implementation since coordinates of the intersection points are integer value and hardware implementation always prefer to integer operation.

In a second implementation form of the decoder according to the first implementation form of the second aspect, the offset between the final GP line and the selected GP line comprises an offset between the start point of the selected GP line and a start point of the final GP line, and an offset between the end point of the selected GP line and an end point of the final GP line.

In a third implementation form of the decoder according to any implementation form of the second aspect, the template list comprises two or more candidate GP lines, the candidate GP line specific line information further comprises an index for each of the candidate GP lines, and the geometric partitioning parameter further includes an index of the selected GP line.

In a fourth implementation form of the decoder according to the third implementation form of the second aspect, the partitioning/prediction unit is configured to select the candidate GP line from the template according to the decoded index of the selected GP line.

In a fifth implementation form of the decoder according to any implementation form of the second aspect wherein the offset information comprises a step size and a quantized offset value, wherein an offset between the final GP line and the selected GP line is determined based on a product of the step size and the quantized offset value.

By using the step size and the quantized offset value, the signaled side-information relating to the partitioning structure is further minimized.

A further aspect of the present application provides a decoding method for decoding a frame in a video sequence. The decoding method comprises: decoding an encoded geometric partitioning parameter for the current block; obtaining a template list including line information representing one or more candidate geometric partitioning (GP) lines, selecting a GP line from the template list of the one or more GP lines to obtain a selected GP line, and obtaining, based on the decoded geometric partitioning parameter and the selected GP line, the final GP line that partitions the current block into two segments, wherein the geometric partitioning parameter includes an offset information indicating an offset between the final GP line and the selected GP line.

Features of implementation forms of the decoding method of this further aspect correspond to the features of the respective implementation forms of the decoder of the second aspect.

### BRIEF DESCRIPTION OF THE DRAWINGS

The above described aspects and implementation forms of the present application will be explained in the following description of specific embodiments in relation to the enclosed drawings, in which

FIG. 1 shows examples for traditional partitioning methods.

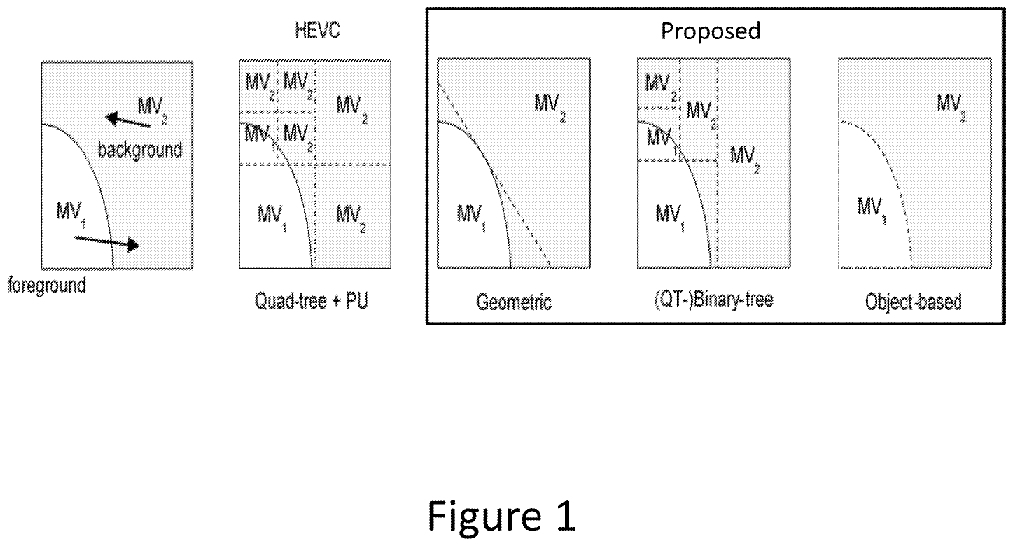

FIG. 2 shows an encoder according to an embodiment of the present application.

FIG. 3a shows a block diagram of the partitioning unit of the encoder for inter prediction.

FIG. 3b shows a block diagram of the partitioning unit of the encoder for intra prediction.

FIG. 4 shows a template list according to an embodiment of the present application.

FIG. 5 shows a decoder according to an embodiment of the present application.

FIG. 6a shows a block diagram of the partitioning unit of the decoder for inter prediction.

FIG. 6b shows a block diagram of the partitioning unit of the decoder for intra prediction.

FIG. 7 shows a process of decoding the flags included in a GP parameter.

### DETAILED DESCRIPTION OF THE EMBODIMENTS

Illustrative embodiments of an apparatus, a method and a program product for encoding an image using intra-prediction coding are described with reference to the various figures. Although this description provides a detailed example of possible implementations, it should be noted that the details are intended to be exemplary and in no way limit the scope of the application.

Any terminology mentioned in one embodiment/example is applicative to the other embodiments/examples. A certain embodiment/example may reference to other embodiments/examples.

The present application is relevant to an encoder, decoder, computer program and computer program product for processing a frame of a video sequence.

### Embodiment 1: Encoder

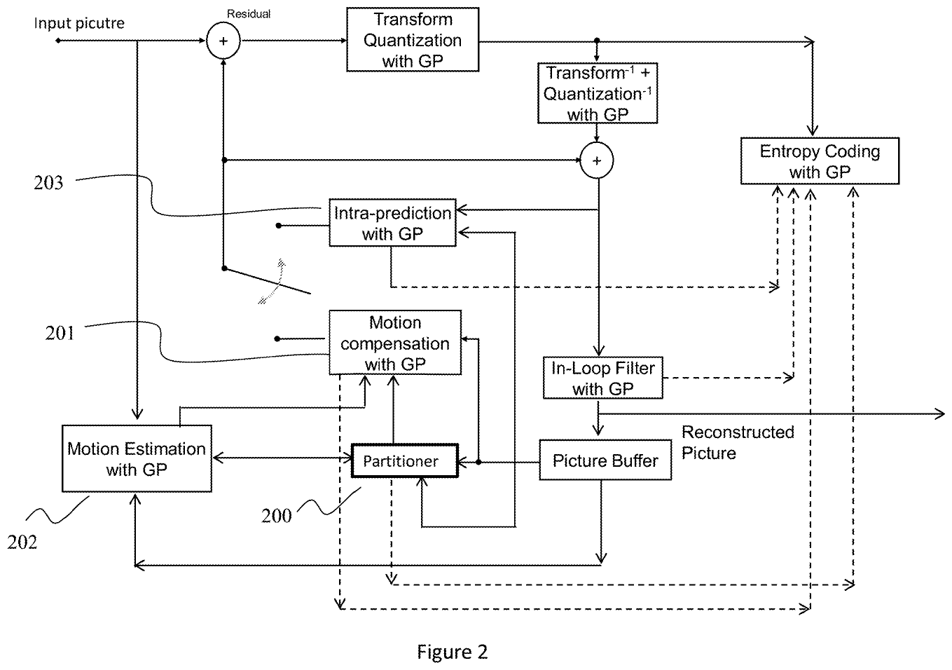

FIG. 2 shows an example of an encoder for encoding a frame of a video sequence. In FIG. 2, the geometric block partitioning used for motion estimation and motion compensation is generated by a partitioning unit (e.g. partitioner) 200.

The partitioning unit 200 is connected to both of the motion estimation unit 202 and motion compensation unit 201 for inter prediction and the intra estimation/prediction unit 203 for intra prediction. As partitioning and motion/intra estimation for GP can be considered a coupled optimization problem, which is typically performed in an iterative manner, the information between partitioning unit 200 and motion/intra estimation may flow in both directions.

In an example, the partitioning unit 200 may also perform an analysis of the original input image to obtain an initial partitioning for increased encoder performance. Using this block partitioning, segment-wise motion estimation or intra estimation is performed and a rate-distortion cost is calculated. A partitioning refinement step is performed, followed by another motion estimation or motion estimation refinement or intra estimation step. This iterative process may continue for a fixed amount of cycles or until a certain rate-distortion threshold is met.

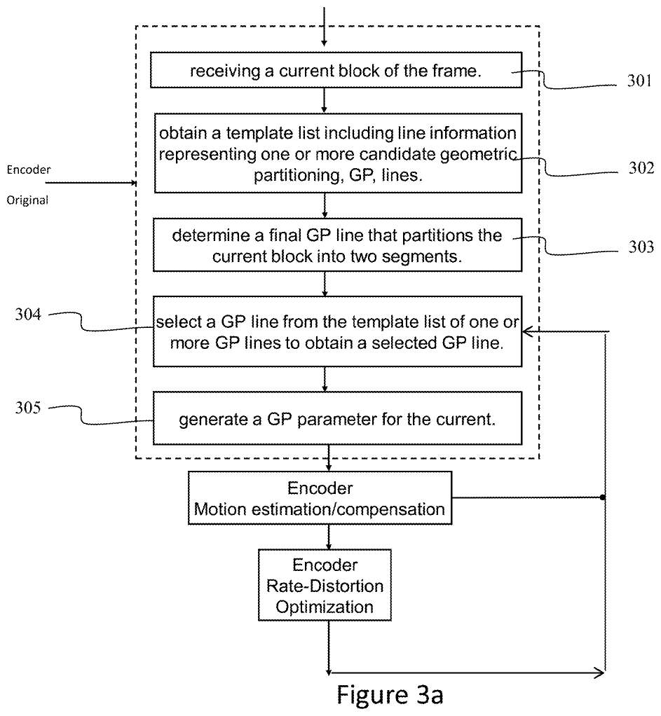

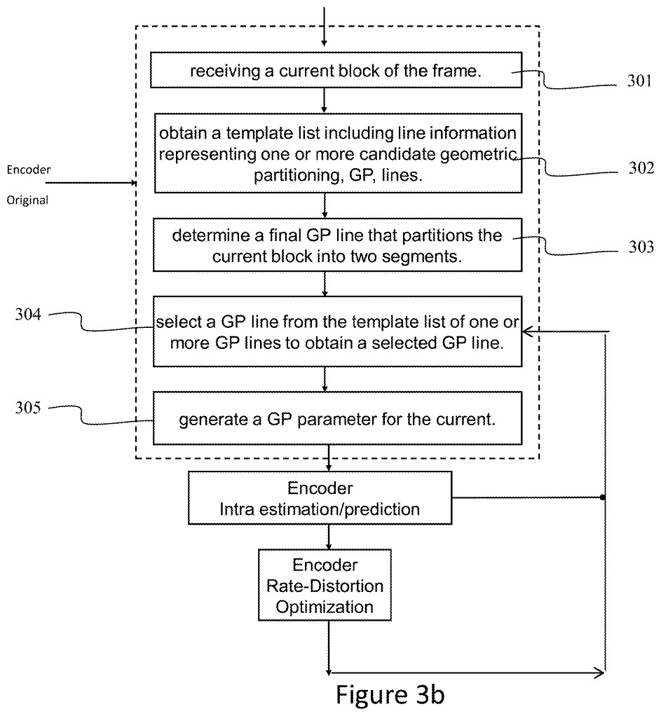

FIG. 3a shows a block diagram of the partitioning unit 200 for inter prediction. FIG. 3b shows a block diagram of the partitioning unit 200 for intra prediction. Aspects of the partitioning unit 200 are encircled by the dashed line. Input of the partitioning unit 200 is the current reconstructed picture along with all side-information relating to the reconstructed picture, such as intra-prediction modes, motion vectors and partitioning information of the neighbor blocks.

A main aspect of the present application concerns the partitioning unit 200 as exemplarily shown in FIG. 3a and FIG. 3b, and the entropy coding of the GP parameter generated by the partitioning unit 200.

Correspondingly, the encoder of the present application may mainly comprise a partitioning unit and an entropy coding unit. The partitioning unit is configured to generate a GP (geometric partitioning) parameter for a current block while the entropy coding unit is configured to encode the GP parameter.

To generate the GP parameter, the partitioning unit is configured to perform following steps 301-306.

Step 301. receiving a current block of the frame;

Step 302. obtaining a template list including line information representing one or more candidate geometric partitioning, GP, lines.

The list may be in different forms or formats, such as table, information sequence, and so on.

The partitioning unit may obtain the list by generate the list or by reading it from its local storage (internal or external).

The template list comprises two or more candidate GP lines. The partitioning unit may be configured to select the candidate GP line from the template list that is closest to the final GP line as the selected GP line. The partitioning unit may also be configured to select the candidate GP line from the template list such that a rate distortion is minimized.

Each candidate GP line is generated based on a template block and a start point and an end point that are arranged on a boundary of the template block. The size of the template block is associated to the template list. The size of the template block may be same as or different from the current block. The number of the candidate GP lines can be fixed or can depend on size of the current block.

The encoder may generate and store different template lists corresponding to different template blocks having different sizes. When processing a current block, the partitioning unit uses a template list generated based on a template block whose size is the same as the current block. For example, the partitioning unit may be configured to determine the size of the current block and select a template list associated to the size of the current block.

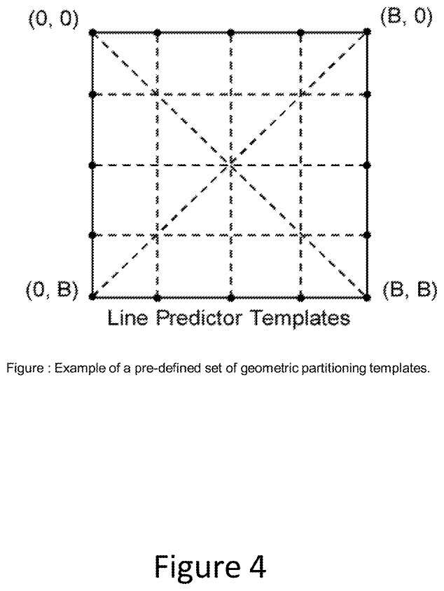

Each candidate GP line on a template list may have a line index. For each template list, a unique mapping between a line index (e.g. template index GP_TemplateIdx) and two (x,y) coordinate pairs (xs, ys), (xe, ye) may be preset, where the coordinate pairs specify the straight GP line which is to be used to split the current block into two segments. This is exemplified in FIG. 4, where each dashed line specifies a template GP line and a total of eight different templates or template GP lines is shown.

An example mapping of the templates in FIG. 4 is given in Table 1, where the coordinates of the partitioning line depend on the block size B. The mapping may be fixed for all pictures of the sequence or may be configurable. A new mapping table may be signalled to the decoder or may be generated based on the probability of GP_TemplateIdx in already coded blocks.

TABLE 1
Mapping list from the template index to the respective
coordinate pair of the geometric partitioning line

| GP_TemplateIdx | (xs, ys) | (xe, ye) |
|---|---|---|
| 0 | (0, 0) | (B, B) |
| 1 | (B, 0) | (0, B) |
| 2 | (0, B/2) | (B, B/2) |
| 3 | (B/2, 0) | (B/2, B) |
| 4 | (0, B/4) | (B, B/4) |
| 5 | (0, 3B/4) | (B, 3B/4) |
| R6 | (B/4, 0) | (B/4, B) |
| 7 | (3B/4, 0) | (3B/4, B) |
| . . . | | |

As another example of the possible templates, any two different points respectively located on the two boundaries of a given block with size B can be used to form a straight line, which divides the given block and can be used as one template. That is a candidate GP line may be an oblique line instead of a horizontal or vertical line. Therefore a template list may include any one or any combination of oblique line(s), horizontal line(s) and vertical line(s). If the number of the candidate GP lines is large, the cost to code the template index increases.

When including an oblique line, the above table 1 includes mapping for the oblique line.

For example:

| GP_TemplateIdx | (xs, ys) | (xe, ye) |
|---|---|---|
| . . . | . . . | . . . |
| i | (0, B/4) | (B, 1B/2) |
| . . . | . . . | . . . |

Step 303. determining a final GP line that partitions the current block into two segments.

The partitioning unit may be configured to determine the final GP line by performing sub steps 303a-303b:

303a. selecting (e.g. randomly select) a candidate GP line from the template list as an initial GP line; and

303b. repeatedly modifying the selected initial GP line to obtain a modified GP line, calculating a rate distortion cost for the modified GP line, and selecting the modified GP line as the final GP line if the rate distortion cost of the modified GP line is below or equal to a threshold.

Optionally, the partitioning unit may also be configured to determine the final GP line by performing the above substep 303a and following sub steps 303c-303d:

303c. repeatedly modifying the selected initial GP line to obtain a plurality of modified GP lines, calculating a rate distortion cost for each of the plurality of modified GP lines, and

303d. selecting the modified GP line with the smallest rate distortion cost.

Optionally, the partitioning unit is configured to obtain the final GP by performing an analysis of the original texture of the current block (i.e. based on content of the video).

Step 303 may be performed before or after step 302.

Step 304. selecting a GP line from the template list of one or more GP lines to obtain a selected GP line.

As mentioned in the aforementioned step 302, the template list may involve one or more candidate GP lines.

If the list comprises two or more candidate GP lines, the partitioning unit is configured to select the candidate GP line from the list by different ways. For example, the partitioning unit may select a GP line that is closest to the final GP line as the selected GP line. For another example, the partitioning unit can select the candidate GP line from the list such that a rate distortion is minimized as the selected GP line.

Step 305. generating a GP parameter for the current block, wherein the GP parameter includes an offset information indicating an offset between the final GP line and the selected GP line.

The GP parameter includes an offset information indicating an offset between the final GP line and the selected GP line.

The GP parameter may further include information of the selected GP line. For example, if the template list comprises two or more candidate GP lines, the candidate GP line specific line information further comprises a unique line index for each of the candidate GP lines, and correspondingly the information of the selected GP line includes a line index of the selected GP line.

The offset information comprises a step size and a quantized offset value, wherein an offset between the final GP line and the selected GP line corresponds to a product of the step size and the quantized offset value. This solution further minimizes the signalled side-information relating to the partitioning structure. Alternatively, the offset information can be encoded directly without the step size and the quantized offset.

For example, a candidate GP line on the list may be represented by two coordinate pairs (xₚ, yₚ)={(xₛ, yₛ), (xₑ, yₑ)}, which specify the start- and end-points of the GP line. To further refine the GP prediction, two offset values Δ={Δs, Δe} may be applied to the start- and end-point to reach the final GP partitioning line (x_{f}, y_{f})={(x_{s,f}, y_{s,f}), (x_{e,f}, y_{e,f})}. Each offset value A is a signed integer, where the sign determines the direction and the value determines the number of pixels/samples multiplied by a quantization and block size B dependent step size k_{QP} by which the respective predicted point is moved. In case the step size k_{QP} is not fixed, step size k_{QP} can be encoded and transmitted from an encoder to a decoder. The final GP partitioning line (x_{f}, y_{f}) and each offset value A are represented by following equations (1)-(3).

$$\begin{matrix}( \begin{matrix}{x}_{f} \\ {y}_{f}\end{matrix} ) = ( \begin{matrix}{x}_{p} \\ {y}_{p}\end{matrix} ) + {k}_{QP} \cdot Δ \cdot ( \begin{matrix}{v}_{1} \\ {v}_{2}\end{matrix} ) & ( 1 ) \\ ( \begin{matrix}{Δ}_{s , x} \\ {Δ}_{s , y}\end{matrix} ) = ( \begin{matrix}{x}_{f , s} \\ {y}_{f , s}\end{matrix} ) - ( \begin{matrix}{x}_{p , s} \\ {y}_{p , s}\end{matrix} ) & ( 2 ) \\ ( \begin{matrix}{Δ}_{e , x} \\ {Δ}_{e , y}\end{matrix} ) = ( \begin{matrix}{x}_{f , e} \\ {y}_{f , e}\end{matrix} ) - ( \begin{matrix}{x}_{p , e} \\ {y}_{p , e}\end{matrix} ) & ( 3 )\end{matrix}$$

Parameters v₁ and v₂ may be used to control the direction of offset adjustment. They are used in the equation. The values of v1 and v2 may depend on the values of (xₚ, yₚ) and Δ as shown in the following exemplary table 1:

TABLE 1
Parameterization of the block boundary.

| xₚ | yₚ | Δ | v₁ | v₂ |
|---|---|---|---|---|
| 0 | 0 | >0 | 1 | 0 |
| 0 | 0 | <0 | 0 | 1 |
| 0 < xₚ < B | 0 | — | 1 | 0 |
| B | 0 | >0 | 0 | 1 |
| B | 0 | <0 | 1 | 0 |
| B | 0 < yₚ < B | — | 0 | 1 |
| B | B | >0 | 1 | 0 |
| B | B | <0 | 0 | 1 |
| 0 < xₚ < B | B | — | 1 | 0 |
| 0 | B | >0 | 0 | 1 |
| 0 | B | <0 | 1 | 0 |
| 0 | 0 < yₚ < B | — | 0 | 1 |

As mentioned, the step size k_{QP} may depend on the block size and the quantization parameter. For big blocks or high quantization parameters, a large k_{QP} can be used. For small blocks or low quantization parameter, a small k_{QP} can be used. As an example, k_{QP} can be 4 for 128×128 blocks, k_{QP} can be 2 for 64×64 blocks and k_{QP} can be 1 for blocks not larger than 64×64. Further, k_{QP} may be adapted according to the angle of initial partitioning line. As one example, the partition of the template block can be used as initial partitioning line. If an initial partition has a small angle, a small k_{QP} is preferred. If an initial partition is a steep line, a big k_{QP} is preferred.

Step 306, generating a binary pattern by using the final GP line parameters.

For the object of the present application, step 306 is optional. The binary pattern labels each pixel/sample depending on which side of the partitioning line the pixel/sample lies. To determine the rasterized points, which represent the closest representation of the straight line given the two points, the well-known Bresenham line algorithm may be employed.

At the encoder side, the determination of the offset values Δ={Δs, Δe} is again subject to a rate-distortion optimization process. Typically, an iterative approach is chosen, consisting of consecutive steps of motion estimation using the GP pattern and variation of the GP offsets until a rate-distortion criterion is minimized.

As an example, a binary mask/pattern M(x,y) assigning each pixel/sample of a given block to a specific segment can be derived using the two following equations (7)-(8):

$$\begin{matrix}f ( x , y ) = \vert \begin{matrix}{x}_{s} - x & {y}_{s} - y \\ {x}_{e} - x & {y}_{e} - y\end{matrix} \vert & ( 7 ) \\ M ( x , y ) \{ \begin{matrix}0 , & if f ( x , y ) \geq 0 \\ 1 , & \text{otherwise}\end{matrix} & ( 8 )\end{matrix}$$

In equations (7)-(8), (xₛ, yₛ) and (xₑ, yₑ) are the starting and ending points of the partitioning line.

In above step 302, the list may comprise for each candidate GP line of the one or more candidate GP lines a candidate GP line specific line information that may be in following form (i) or (ii):

(i) the candidate GP line specific line information comprises a coordinate (x,y) indicating a start point and a coordinate indicating an end point of the respective candidate GP line of the one or more candidate GP lines.

The start point and the end point are two intercept points lying on the boundary of the current block. The offset between the final GP line and the selected GP line comprises an offset between the start point of the selected GP line and a start point of the final GP line, and an offset between the end point of the selected GP line and an end point of the final GP line.

Due to the coding of GP parameters using boundary intercept values (which e.g. can be the relative coordinate values of the two intercept points using the top, left point of a coding block as the origin coordinates (0,0)), a hardware-friendly integer based implementation is achievable unlike GP methods using angle and distance pairs. The coordinates of the intersection points are integer values. For hardware implementations integer operations are advantageous.

(ii) the candidate GP line specific line information comprises a radius p or a distance (i.e. length of radius) between the respective candidate GP line of the one or more candidate GP lines and a center of the current block, and an angle 9 of the respective candidate GP line of the one or more candidate GP lines.

The radius and angle two parameters can model the partitioning by:

f(x,y)=x cos θ+y sin θ−p

The radius is vertical/orthogonal to the respective candidate GP line of the one or more candidate GP lines. The angle may be an angle between the candidate GP line and an axis (horizontal or vertical) of the current block, or between the radius and an axis of the current block.

Besides the list generated based on a template block, a spatial list may be involved. For example, the spatial list may comprise candidate GP lines generated based on information of a neighbor block of the current block. Correspondingly, steps 302-305 are replaced with following steps 302′-305′ that are different from steps 303-305 by including an additional spatial list and information relevant to the spatial list.

302′. obtain a spatial list and a template list.

The template list includes including line information representing one or more candidate GP lines.

303′. determine a final GP line that partitions the current block into two segments;

304′. select a GP line from the spatial list and the template list to obtain a selected GP line. The selected GP line may be from the spatial list or the template list.

305′. generate a GP parameter for the current block, wherein the GP parameter includes an offset information indicating an offset between the final GP line and the selected GP line. For example, the GP parameter may comprise following flags:

(i) GP Mode Signalling Flag

The GP mode signalling flag may be a GP_CU_Flag. For each inter-predicted block, a GP_CU_Flag is coded, which specifies if GP is used for the current block. Otherwise, if the codec also supports rectangular motion partitioning, those partitioning structures are signalled.

If GP is used for the current block, the GP_CU_Flag is set to be true and the following Prediction mode flag is coded.

Optionally, the GP_CU_Flag may be coded using context-adaptive-binary-arithmetic-coding using different contexts, depending on the GP mode usage of the current blocks neighborhood.

(ii) Prediction Mode Flag

The Prediction mode flag indicates that the selected GP line is from the template list or the spatial list. The Prediction mode flag may be GP_PredictionMode_Flag.

If the GP_PredictionMode_Flag is false, the following unsigned line index for the template list is coded.

If the GP_PredictionMode_Flag is true, the following line index for the spatial list is coded.

Optionally, The GP_Prediction_Mode_Flag may also be entropy coded using CABAC and use different models depending on information of the neighbor block.

(iii) Line Index for the Template List

This line index specifies which candidate GP line on the template list is used. The index addresses a specific entry of a template list. An example of this index may be GP_TemplateIdx.

The list index may be binarized using truncated unary coding, which is displayed in table 2.

TABLE 2
Truncated unary coding of the list index value.

| List Index | Code |
|---|---|
| 0 | 0 |
| 1 | 10 |
| 2 | 110 |
| 3 | 1110 |
| . . . | . . . |

(iv) Line Index for the Spatial List

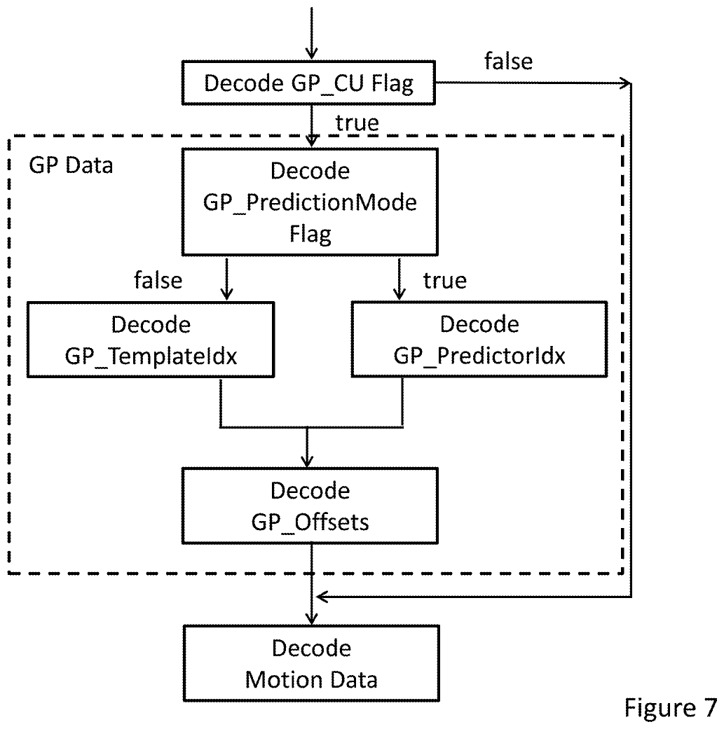

This index specifies that a candidate GP line on the spatial list is used. The index addresses a specific entry of the spatial list. An example of this index may be GP_PredictorIdx in FIG. 7.

(v) Two Integer Offset Values

These offset values specify how the selected GP line is refined to obtain the final GP line. Motion data such as motion vectors, motion vector differences, reference frame indices or motion vector merging data is coded after the partitioning. These offset values may be GP_Offsets={Δs, Δe}.

The offset values may be binarized using a combination of a larger than zero flag (LZ-Flag), a sign flag (S-Flag) and a combination of Truncated Rice coding with an appended Exp-Golomb code for the remaining value. An example of such a coding scheme is given in table 3.

TABLE 3
Exemplified coding of the offset values for geometric partitioning lines.
Here, a coding using a larger-zero flag, a sign-flag and a code using
Truncated Rice and Exp-Golomb coding is used.

| Offset Value | LZ-Flag | S-Flag | Remainder Code |
|---|---|---|---|
| . . . | . . . | . . . | . . . |
| −2 | 1 | 1 | 10 |
| −1 | 1 | 1 | 0 |
| 0 | 0 | — | — |
| 1 | 1 | 0 | 0 |
| 2 | 1 | 0 | 10 |
| 3 | 1 | 0 | 110 |
| 4 | 1 | 0 | 1110 |
| 5, 6 | 1 | 0 | 11110{0, 1} |
| 7, . . . , 10 | 1 | 0 | 111110{0, 1}{0, 1} |
| . . . | . . . | . . . | . . . |

Context adaptive coding may be used for the LZ-Flag, S-Flag and code word bins which are part of the Truncated Rice code, while the appended Exp-Golomb code may be coded in bypass mode, meaning no context adaption for the remaining bins is applied and an equiprobable distribution is assumed.

### Embodiment 2: Decoder

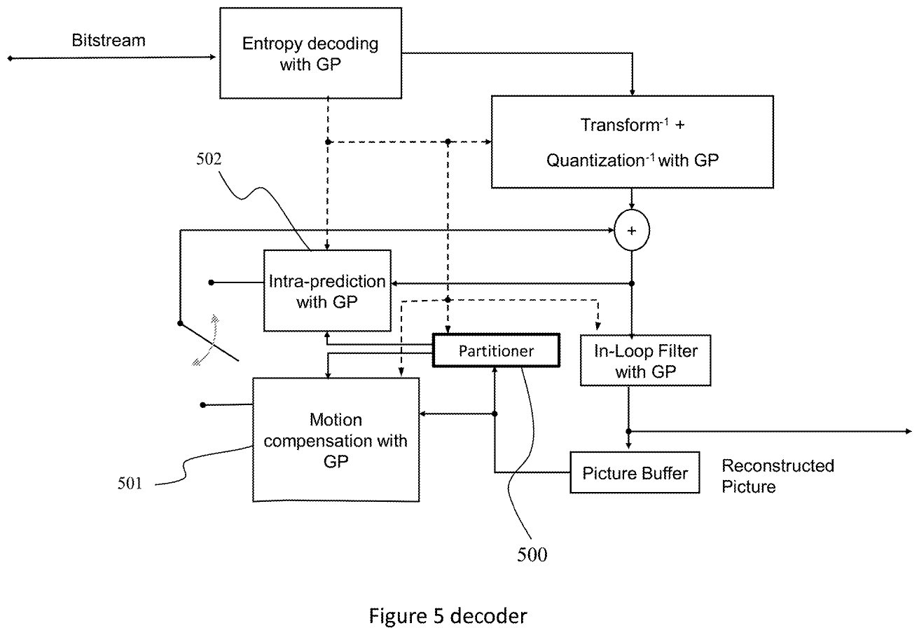

FIG. 5 shows an example of a decoder for decoding a frame of a video sequence. In FIG. 5, the geometric block partitioning used for motion compensation is generated by a partitioning unit (e.g. partitioner) 500.

The partitioning unit 500 is connected to both of the motion compensation unit 501 for inter prediction and the intra prediction unit 502 for intra prediction. Input of the partitioning unit 500 are the decoded GP parameter of the current block and the reconstructed blocks along with all side-information relating to the reconstructed blocks, such as intra-prediction modes, motion vectors and partitioning information of the neighbor blocks.

The main aspect of the present application concerns the partitioning unit 500 and the entropy decoding of the GP parameter generated by the partitioning unit 500.

Correspondingly, the decoder of the present application mainly comprises an entropy decoding unit and a partitioning unit. The entropy decoding unit is configured to decode an encoded GP parameter for a current block. The GP parameter is same as the GP parameter described in the aforementioned encoder embodiment (e.g. step 305, step 305′, GP mode signaling flag, Prediction mode flag, Line index for the template list, Line index for the spatial list, two integer offset values).

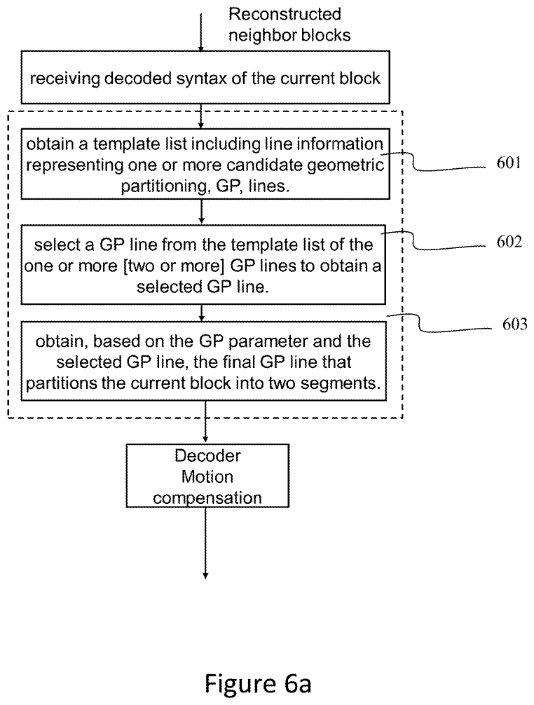

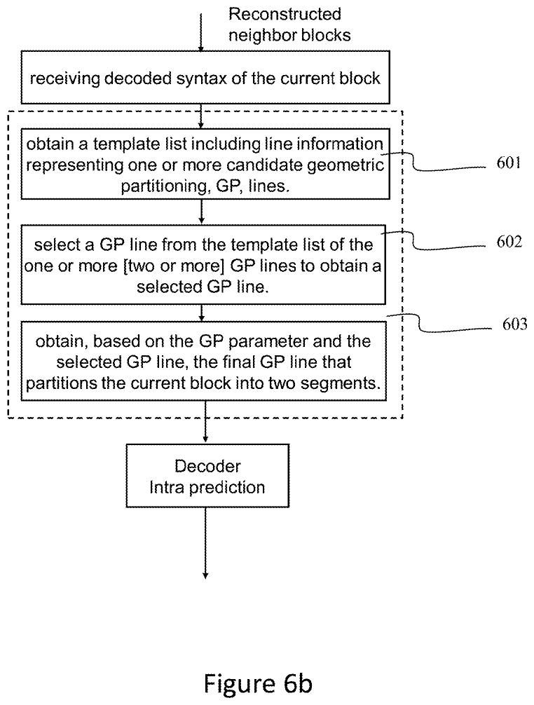

The partitioning unit is configured to perform following steps 601-603 shown in FIG. 6a-6b. FIG. 6a involves inter prediction while FIG. 6b involves intra prediction.

Step 601. obtaining a template list including line information representing one or more candidate geometric partitioning, GP, lines. The template list is same as the list in the aforementioned encoder embodiment (e.g. step 302). This step is independent from the decoded GP parameter. The partitioning unit may obtain the template list by generate it or by reading it from its local storage (internal or external).

The template list may comprise for each candidate GP line a candidate GP line specific line information. For example, the candidate GP line specific line information comprises a coordinate (x,y) indicating a start point and a coordinate indicating an end point of each of the respective candidate GP line of the one or more candidate GP lines. For another example, the candidate GP line specific line information comprises a distance or radius between the respective candidate GP line of the one or more candidate GP lines and a center of the current block, and an angle of the respective candidate GP line of the one or more candidate GP lines. If the list involves two or more candidate GP lines, the candidate GP line specific line information may further include a line index.

Step 602. selecting a GP line from the template list of the one or more GP lines to obtain a selected GP line.

The decoded GP parameter may further include information of the selected GP line that includes following examples.

The information of the selected GP line may be a line index of the selected GP line. In this case, the partitioning unit 500 may generate in the step 601 one or more candidate GP lines and select in this step 602 a candidate GP line corresponding to the decoded line index as the selected GP line. It can be seen that in this case the list is generated independent of the decoded GP parameter.

Optionally, the GP parameter does not include information of the selected GP line. In this case, the partitioning unit 500 may generate, in the above step 601, one candidate GP line which is same as the one generated by the encoder and take it as the selected GP line in this step 602. That is, both of the encoder (e.g. its partitioning unit) and the decoder (e.g. its partitioning unit) use (e.g. generate or read from a storage) a list comprising only one candidate GP line.

Step 603. obtaining, based on the decoded geometric partitioning parameter and the selected GP line, the final GP line that partitions the current block into two segments, wherein the geometric partitioning parameter includes an offset information indicating an offset between the final GP line and the selected GP line.

As mentioned above, the decoded GP parameter may comprise an offset. Therefore, the partitioning unit is able to obtain the final line through the selected GP line plus the offset. For example, if the offset is coded using step size and quantization, the final offset is obtained based on the equations (1)-(3) and table 1 in the above encoder embodiment.

The portioning unit 500 may be further configured to perform following step 604.

Step 604. generating a binary pattern by using the final GP line parameters.

For the object of the present application, step 604 is optional. The binary pattern is same as the aforementioned step 306 of the encoder embodiment. At the decoder side, the generated binary pattern/mask is used for motion compensation.

Besides the list generated based on the above template list, a spatial list may be involved. For example, the spatial list is same as the one in the aforementioned encoder embodiment. Correspondingly, steps 601-603 are replaced with following steps 601′-603′ that are different from steps 601-603 by including an additional spatial list and information relevant to the spatial list:

Step 601′. obtaining a template list and a spatial list. Each of the template list and a spatial list includes line information representing one or more candidate GP lines.

As an alternative implementation, each list may include only one candidate GP line.

Step 602′. selecting a GP line from the spatial list and the template list to obtain the selected GP line.

The partitioning unit may select the GP line based on the decoded GP parameter. For example, the GP parameter may include a line index of the selected GP line and a list index of one list (spatial or template list). Therefore the partitioning unit is able to select, from the list corresponding to the list index, a candidate GP line corresponding to the line index as the selected GP line.

Step 603′. obtaining, based on the decoded GP parameter and the selected GP line, the final GP line that partitions the current block into two segments. The geometric partitioning parameter includes an offset information indicating an offset between the final GP line and the selected GP line.

The portioning unit 500 may be further configured to perform following step 604′.

Step 604′. generating a binary pattern by using the final GP line parameters.

The process of decoding the flags described in the aforementioned step 305′ is illustrated in FIG. 7.

Although embodiments of the application may have been mainly described with regard to encoder and decoder embodiments of the application, the disclosure equally applies to encoding method and decoding method embodiments of the application, and vice versa where applicable.

Embodiments of the application may be implemented as hardware, firmware, software or any combination thereof. For example, the functionality of an embodiment may be performed by a processor, a microcontroller, a digital signal processor (DSP), a field programmable gate array (FPGA), an application-specific integrated circuit (ASIC), or the like.

The functionality of an embodiment may be implemented by program instructions stored on a computer readable medium. The program instructions, when executed, cause the computer, processor or the like, to perform the steps of the encoding and/or decoding methods. The computer readable medium can be any medium on which the program is stored such as a read only memory (ROM), a random access memory (RAM), a Blu ray disc, DVD, CD, USB (flash) drive, hard disc, server storage available via a network, etc.

Embodiments of the application may be implemented in various devices including a TV set, set top box, PC, tablet, smartphone, or the like. The functionality may be implemented by means of a software, e.g. an app implementing the method steps.

In other words, ALL of the processes described above may be implemented in a computer program, software, and/or firmware incorporated in a computer-readable medium for execution by a computer and/or processor. For example, an encoder for encoding a frame in a video sequence may comprise a processor, wherein the processor is configured to perform the steps described in the above encoder embodiment. For another example, a decoder for decoding a frame in a video sequence may comprise a processor, wherein the processor is configured to perform the steps described in the above decoder embodiment. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1. A method for encoding a frame of a video sequence, applied to an encoder comprising a digital signal processor, the method comprising:
receiving a current block of the frame;
obtaining a template list including line information representing one or more candidate geometric partitioning lines;
determining a final GP line that partitions the current block into two segments;
selecting a GP line from the template list of one or more GP lines to obtain a selected GP line; and
generating a GP parameter for the current block, wherein the GP parameter includes offset information indicating an offset between the final GP line and the selected GP line; and
encoding the GP parameter.

2. The method according to claim 1, wherein the template list comprises, for each candidate GP line of the one or more candidate GP lines, a candidate GP line specific line information,
wherein the candidate GP line specific line information comprises one of the following (a) and (b):
(a) a coordinate (x,y) indicating a start point and a coordinate indicating an end point of the respective candidate GP line of the one or more candidate GP lines; and
(b) a distance between the respective candidate GP line of the one or more candidate GP lines and a center of a template block, and an angle of the respective candidate GP line of the one or more candidate GP lines.

3. The method according to claim 2, wherein the offset between the final GP line and the selected GP line comprises an offset between the start point of the selected GP line and a start point of the final GP line, and an offset between the end point of the selected GP line and an end point of the final GP line.

4. The method according to claim 2, wherein the template list comprises two or more candidate GP lines, the candidate GP line specific line information further comprises an index for each of the candidate GP lines, and the GP parameter further includes an index of the selected GP line.

5. The method according to claim 1, wherein the template list comprises two or more candidate GP lines, and the method further comprises one of the following (a) and (b):
(a) selecting the candidate GP line from the template list that is closest to the final GP line as the selected GP line; and
(b) selecting the candidate GP line from the template list such that a rate distortion is minimized.

6. The method according to claim 1, wherein determining the final GP line comprises:
selecting a candidate GP line from the template list as an initial GP line; and
implementing at least one of the following (a) and (b):
(a) repeatedly modifying the selected initial GP line to obtain a modified GP line, obtaining a rate distortion cost for the modified GP line, and selecting the modified GP line as the final GP line, wherein the rate distortion cost of the modified GP line is below or equal to a threshold; and
(b) repeatedly modifying the selected initial GP line to obtain a plurality of modified GP lines, obtaining a rate distortion cost for each of the plurality of modified GP lines, and selecting the modified GP line with the smallest rate distortion cost.

7. The method according to claim 1, wherein the offset information comprises a step size and a quantized offset value, wherein an offset between the final GP line and the selected GP line is associated with a product of the step size and the quantized offset value.

8. A method for decoding a frame in a video sequence, applied to a decoder comprising a digital signal processor, the method comprising:
decoding an encoded geometric partitioning parameter for the current block;
obtaining a template list including line information representing one or more candidate geometric partitioning lines;
selecting a GP line from the template list of the one or more GP lines to obtain a selected GP line; and
obtaining, based on the decoded GP parameter and the selected GP line, the final GP line that partitions the current block into two segments, wherein the GP parameter includes offset information indicating an offset between the final GP line and the selected GP line.

9. The method according to claim 8, wherein the template list comprises for each candidate GP line of the one or more candidate GP lines a candidate GP line specific line information,
wherein the candidate GP line specific line information comprises one of the following (a) and (b):
(a) a coordinate (x,y) indicating a start point and a coordinate indicating an end point of each of the respective candidate GP line of the one or more candidate GP lines; and
(b) a distance between the respective candidate GP line of the one or more candidate GP lines and a center of a template block, and an angle of the respective candidate GP line of the one or more candidate GP lines.

10. The method according to claim 9, wherein the offset between the final GP line and the selected GP line comprises an offset between the start point of the selected GP line and a start point of the final GP line, and an offset between the end point of the selected GP line and an end point of the final GP line.

11. The method according to claim 9, wherein the template list comprises two or more candidate GP lines, the candidate GP line specific line information further comprises an index for each of the candidate GP lines, and the GP parameter further includes an index of the selected GP line.

12. The method according to claim 11, further comprises: selecting the candidate GP line from the template according to the decoded index of the selected GP line.

13. The method according to claim 8, wherein the offset information comprises a step size and a quantized offset value, wherein an offset between the final GP line and the selected GP line is determined based on a product of the step size and the quantized offset value.

14. An encoder for encoding a frame in a video sequence, comprising a processor, and a memory coupled to the processor and having processor-executed instructions stored thereon, which when executed cause the processor to:
receive a current block of the frame;
obtain a template list including line information representing one or more candidate geometric partitioning lines;
determine a final GP line that partitions the current block into two segments;
select a GP line from the template list of one or more GP lines to obtain a selected GP line;
generate a GP parameter for the current block, wherein the GP parameter includes offset information indicating an offset between the final GP line and the selected GP line; and
encode the current block and the geometric partitioning parameter.

15. A decoder for decoding a frame in a video sequence, comprising a processor, and a memory coupled to the processor and having processor-executed instructions stored thereon, which when executed cause the processor to:
obtain a template list including line information representing one or more candidate geometric partitioning (GP) lines;
select a GP line from the template list of the one or more GP lines to obtain a selected GP line;
decode an encoded GP parameter for the current block, wherein the GP includes an offset information indicating offset between a final GP line and the selected GP line; and
obtain, based on the decoded GP parameter and the selected GP line, the final GP line that partitions the current block into two segments.

16. A non-transitory computer-readable medium having processor-executable instructions stored thereon, which when executed by a computer or a digital signal processor, cause the computer or the digital signal processor to implement the method according to claim 1.

17. A non-transitory computer-readable medium having processor-executable instructions stored thereon, which when executed by a computer or a digital signal processor, cause the computer or the digital signal processor to implement the method according to claim 8.

18. (canceled)

19. (canceled)

20. The encoder according to claim 14, wherein the template list comprises, for each candidate GP line of the one or more candidate GP lines, a candidate GP line specific line information,
wherein the candidate GP line specific line information comprises one of the following (a) and (b):
(a) a coordinate (x,y) indicating a start point and a coordinate indicating an end point of the respective candidate GP line of the one or more candidate GP lines; and
(b) a distance between the respective candidate GP line of the one or more candidate GP lines and a center of a template block, and an angle of the respective candidate GP line of the one or more candidate GP lines.

21. The encoder according to claim 18, wherein the offset between the final GP line and the selected GP line comprises an offset between the start point of the selected GP line and a start point of the final GP line, and an offset between the end point of the selected GP line and an end point of the final GP line.

22. The decoder according to claim 15, wherein the template list comprises, for each candidate GP line of the one or more candidate GP lines, a candidate GP line specific line information,
wherein the candidate GP line specific line information comprises one of the following (a) and (b):
(a) a coordinate (x,y) indicating a start point and a coordinate indicating an end point of the respective candidate GP line of the one or more candidate GP lines; and
(b) a distance between the respective candidate GP line of the one or more candidate GP lines and a center of a template block, and an angle of the respective candidate GP line of the one or more candidate GP lines.
